(19) United States
(12) Patent Application Publication
(10) Pub. No.: US 2010/0277306 A1
(43) Pub. Date: Nov. 4, 2010

(54) WIRELESS OCCUPANCY SENSING WITH ACCESSIBLE LOCATION POWER SWITCHING

(75) Inventors: Richard A. Leinen, Wilsonville, OR (US); Daniel M. Wright, Beaverton, OR (US)

Correspondence Address: Marger Johnson & McCollom PC - Leviton, 210 SW Morrison, Suite 400, Portland, OR, 97204, US

(73) Assignee: LEVITON MANUFACTURING CO., INC., Little Neck, NY (US)

(21) Appl. No.: 12/434,543

(22) Filed: May 1, 2009

(51) Int. Cl. G08B 1/08

(52) U.S. Cl. 340/539.3

(57) ABSTRACT

A system including an accessible electrical box; a wireless receiver to receive a wireless signal from an occupancy sensor; a power switch to control power to a load; and a controller to control the power switch in response to the wireless signal. The wireless receiver, controller, and power switch are included in the accessible electrical box.

### BACKGROUND

Occupancy sensing technologies are used to monitor the presence of human occupants in indoor and outdoor spaces. Occupancy sensing systems conserve energy by automatically turning off lighting and other electrical loads when the space is unoccupied. They may also perform a convenience function by automatically turning on lighting and other loads when an occupant enters a space.

An occupancy sensing system generally includes at least two major components: an occupancy sensor and a switching device. The sensor generally needs to be positioned in a location that is selected to have a clear view of the entire space that is to be monitored for occupants. Such locations can include ceilings, relatively high on walls, or other relatively inaccessible locations. As controls for an occupancy sensor are generally located on the occupancy sensor itself, the adjustment of these controls can be difficult.

Some controls for occupancy sensors can be included within a power pack. However, power packs are generally installed within ceilings and walls and consequently are as difficult or more difficult to access for adjustment.

### BRIEF DESCRIPTION OF THE DRAWINGS

FIG. 1 illustrates an embodiment of a wireless occupancy sensing system having an accessible electrical box according to some of the inventive principles of this patent disclosure.

FIG. 2 illustrates another embodiment of a wireless occupancy sensing system having an accessible electrical box according to some of the inventive principles of this patent disclosure.

FIG. 3 illustrates another embodiment of a wireless occupancy sensing system having an accessible electrical box according to some of the inventive principles of this patent disclosure.

FIG. 4 illustrates an embodiment of a system mounted in a wall box according to some of the inventive principles of this patent disclosure.

FIG. 5 illustrates an example of the system of FIG. 4 according to some of the inventive principles of this patent disclosure.

FIG. 6 illustrates another example of the system of FIG. 4 according to some of the inventive principles of this patent disclosure.

FIG. 7 illustrates another embodiment of a wireless occupancy sensing system having an accessible electrical box according to some of the inventive principles of this patent disclosure.

### DETAILED DESCRIPTION

Some of the inventive principles of this patent disclosure relate to the use of an accessible electrical box in a wireless occupancy sensing system.

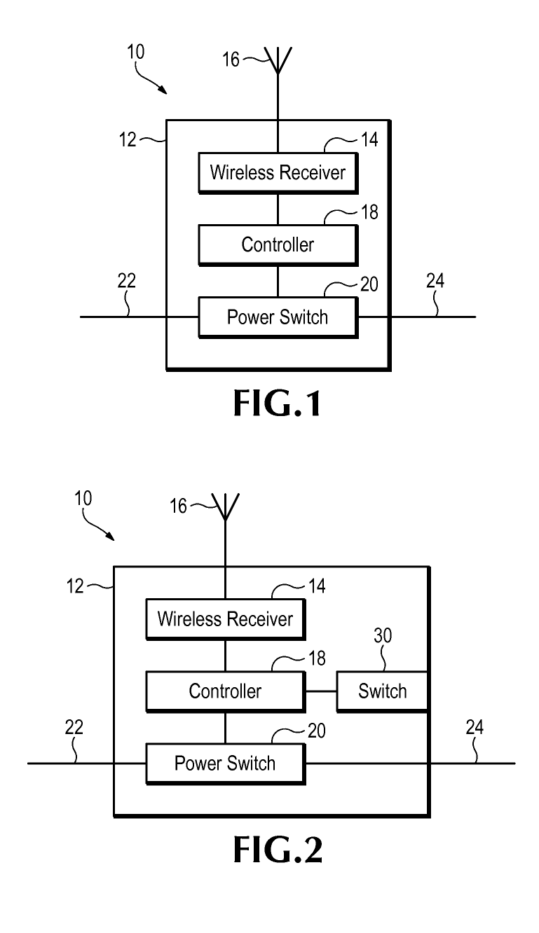

FIG. 1 illustrates an embodiment of a wireless occupancy sensing system having an accessible electrical box according to some of the inventive principles of this patent disclosure. The system 10 includes an accessible electrical box 12. The accessible electrical box 12 includes a wireless receiver 14, a power switch 20, and a controller 18. An accessible electrical box 12 is any enclosure for electrical circuitry or connections that is accessible without removing building materials. For example, an accessible electrical box can include a junction box that is accessible such as a wall box, a ceiling box, a floor box, or the like. In contrast, a junction box or other electrical box that is mounted inside a ceiling, a wall, a floor, or the like is not an accessible electrical box. In other words, accessible includes accessible to an end user. For example, a wall box installed in a wall with a trim plate would be an accessible electrical box. However, a junction box installed in a bathroom ceiling to make a connection between building wiring and an exhaust fan would not be an accessible electrical box.

The wireless receiver 14 is configured to receive a wireless signal from an occupancy sensor. For example, as illustrated, an antenna 16 is coupled to the wireless receiver 14. Accordingly, the wireless receiver 14 can be configured to receive a wireless radio frequency (RF) signal. The wireless receiver 14 can be configured to receive any variety of wireless signals. For example, infrared transmission using a standard from the Infrared Data Association (IrDA), RF transmission using one of the many standards developed by the Institute of Electrical and Electronic Engineers (IEEE), on-off RF modulation, or any other standardized, non-standardized, and/or proprietary wireless communication technology.

Although an antenna 16 has been illustrated, other receiving structures, devices, or the like can be used as appropriate to the medium of the particular wireless signal. Accordingly, the wireless receiver 14 can be coupled to other devices appropriate to receive a particular type of wireless signal. For example, the wireless receiver 14 can be coupled to an infrared detector, an ultrasonic detector, or the like. Furthermore, the wireless receiver 14 can, but need not be limited to a single wireless medium. For example, the wireless receiver 14 can be coupled to devices to receive both infrared signals and RF signals, or any other combination of signals in different media. Moreover, within a particular medium, different signaling techniques can be used. For example, an amplitude modulated RF signal may be used by one wireless device while a frequency modulated RF signal can be used by another wireless device. The wireless receiver 14 can be configured to receive and interpret any of such signals.

The system 10 includes a power switch 20 to control the flow of power between building wiring 22 and wiring 24 which, in some embodiments, may be building wiring. For example, power to an electrical load, such as a light, a fan, an outlet, or any other electrical circuit can be controlled using the power switch 20.

The power switch 20 may include any suitable form of isolated or non-isolated power switch including an air-gap relay, solid state relay, or other switch based on SCRs, triacs, transistors, etc. The power switch 20 may provide power switching in discrete steps such as on/off switching, with or without intermediate steps, or continuous switching such as dimming control.

The controller 18 is configured to control the power switch in response to the wireless signal. For example, the controller 18 can be configured to actuate a relay to open or close to apply power to a load. The controller 18 can include any variety of circuitry. For example, in an embodiment, the controller 18 can be implemented as analog circuitry. In another embodiment, the controller 18 can include digital circuitry such as digital signal processors, programmable logic devices, or the like. In yet another embodiment, the controller 18 can include any combination of such circuitry. Any such circuitry and/or logic can be used to implement the controller 18 in analog and/or digital hardware, software, firmware, etc., or any combination thereof.

In an embodiment, the controller 18 can be configured to provide all of the functionality to process a raw signal from a detector of an occupancy sensor. For example, with an occupancy sensor based on passive-infrared (PIR) sensing technology, the occupancy sensor may include a semiconductor chip with one or more pyroelectric detectors that generate a voltage that changes in response to changes in the amount of infrared energy in the field of view. The wireless signal can include a representation of that voltage. In this example, the controller 18 can include amplifiers, comparators, logic, etc. to determine whether a change in the amount of infrared energy is caused by the motion of an actual occupant or by some other source of infrared energy such as background energy from ambient light. The controller 18 can also include logic to implement features such as a delay time to prevent false unoccupied readings. The controller 18 can be configured to make the final determination of whether the monitored space should be considered occupied.

As described above, the wireless receiver 14 can be configured to receive a variety of wireless signals. In an embodiment, each of these signals can represent a variety of different detectors used in detecting occupancy. For example, some embodiments can include both PIR and ultrasound detectors, in which case, the wireless signal can include signals representing the signals sensed by those detectors, such as the output of the PIR detector, as well as a detected Doppler shift in the output from an ultrasound transducer. The controller 18 can be configured to make an occupancy determination by combining the information contained within the wireless signals from multiple detectors, such as the PIR and ultrasound detectors.

In an embodiment, an occupancy sensor can be configured to transmit an occupied signal. An occupied signal can be a signal that indicates that at a particular time, some indication of an occupant was detected. That is, some amount of processing can be performed on a signal before being transmitted in the wireless signal. For example, the occupied signal can be sent when a detected infrared signal is above a particular threshold, or changes by a specific amount. In another example, an amount of motion detected by an ultrasonic transducer can exceed a threshold.

Note that as used herein, the occupied signal indicates that at a particular time, an indication of occupancy was detected. Such a signal can be transmitted at regular intervals, such as a heartbeat, or at irregular intervals.

The occupancy sensor can be configured to only transmit an occupied signal relating to occupancy. That is, the occupancy sensor can be configured to transmit other types of signal such as control signals, communication signals, or the like. For example, signals transmitted during a learn mode, a teach mode, or the like where the occupancy sensor establishes communication are examples of such other types of signals. However as related to occupancy, the occupied signal can be the only occupancy related signal that is transmitted. For example, while an occupancy sensor is detecting occupancy, the occupancy sensor can be periodically transmitting the occupied signal. However, when occupancy is not detected, by whatever technique, no signal related to occupancy is transmitted. Although an embodiment has been described where the occupied signal is the only occupancy relates signal that is transmitted, in such an embodiment, other occupancy relates signals can be transmitted in other modes, such as in the learn or teach modes described above.

Accordingly, the controller 18 can be configured to process the occupied signal to make a determination whether power should be applied to the wiring 24. For example, once an occupied signal is received and the power is applied by the power switch 20, a timer can be started. If another occupied signal is received before the timer expires, the power can remain applied and the timer can be reset. If another occupied signal is not received before the timer expires, the power can be removed from the wiring 24. Although a timer has been described in making a determination on whether to remove power, time can be tracked in a variety of other ways.

In an embodiment, although a time period has been described after which the controller 18 is configured to cause the power switch 20 to remove power from the load, such a time period can, but need not be constant. For example, a first time period can be used after the controller 18 initially causes the power switch 20 to apply power to the load. If an occupied signal is not received within the first time period, the controller 18 can cause the power switch 20 to remove power from the load. However, if an occupied signal is received, the controller 18 can be configured to subsequently use a second time period. In an embodiment, the second time period can be longer than the first time period.

In another embodiment, additional occupancy related signals can be transmitted. For example, the occupancy sensor can be configured to transmit a non-occupied signal. Accordingly, the controller 18 can receive such a signal to verify that the occupancy sensor is operating.

An occupied signal is distinct from an on-off signal. An on-off signal is a high-level processed signal where the determination to apply or remove power to a load has been determined. Although an embodiment has been described where an occupied signal is used in lieu of an on-off signal, such an on-off signal can be used in another embodiment. Such a signal may have originally been intended to be applied directly to a power switch. An occupancy sensor having complex controls for processing a received signal into an on-off signal can be such a wireless sensor. However, in an embodiment, the on-off signal can be used for a different purpose by the system 10. For example, if an on-off signal can be periodically transmitted by a wireless sensor. Even though the signal received by the wireless receiver 14 was intended to mean on or off, the signal can be used as an indication of what the wireless sensor has detected. If an on signal is periodically received, the on-signal can be interpreted and used as an occupied signal as described above.

Although a single power switch 20 has been illustrated, any number of power switches including power switches of various types, can be used in the system 10. For example, an additional power switch 20 can be coupled to the building wiring 22 and configured to switch power to another set of wiring (not shown). Accordingly, power to multiple loads can be controlled in response to the wireless signal.

Furthermore, the multiple power switches 20 can, but need not be controlled in the same manner. That is, one power switch 20 can be closed while another power switch 20 is opened in response to the same signal in the wireless signal. In another embodiment, one power switch 20 can be responsive to signals from a first occupancy sensor while another power switch 20 can be responsive to signals from a second occupancy sensor. In yet another embodiment, the power switches 20 can be responsive to the same signals in the wireless signal; however, different criteria, such as time delays, sensitivity levels, ambient light levels, or the like can be used in controlling the power switches 20.

FIG. 2 illustrates another embodiment of a wireless occupancy sensing system having an accessible electrical box according to some of the inventive principles of this patent disclosure. In this embodiment, a switch 30 is included in the accessible electrical box. For example, the switch 30 can be an on-off switch, a dimmer switch, a multi-pole switch, rotary switch, momentary switch, or the like. Any type of switch 30 can be used. The controller 18 can be configured to control the power switch 20 in response to the switch 30.

In an embodiment, the controller 18 can receive a switch signal from the switch 30 indicating a state of the switch 30. The switch signal can be anything from a low level signal such as a voltage level generated by closing a single pole single throw switch to a high level signal indicating a dimming level, multi-level state, or the like. For example, the switch 30 can indicate an on-off state. The controller 18 can be configured to control the power switch 20 in response. For example, if an on state is received, the power switch 20 can be controlled to apply power to the wiring 24 and similarly remove power if an off state is received. That is, the switch 30 can be used to override signals received by the wireless receiver 14.

In an embodiment, the controller 18 can be configured to selectively respond to signals received from an occupancy sensor. For example, if the controller 18 is currently causing the power switch to not apply power to a load, the controller 18 can not cause the power switch 20 to apply power in response to occupied signals from an occupancy sensor. If the controller 18 causes the power switch 20 to apply power due to a switch signal, the controller 18 can then respond to occupied signals as described above. For example, the controller 18 can cause the power switch 20 to continue to apply power to the load until an occupied signal is not received within a time period.

In an embodiment, the controller 18 can respond to some occupied signals received while the power switch 20 is not applying power to a load. For example, if the controller 18 has caused the power switch 20 to remove power from the load, the controller 18 can respond to occupied signals received within a time period after the power is removed. After the expiration of the time period, the controller 18 can be configured to again not cause the power switch 20 to apply power in response to occupied signals.

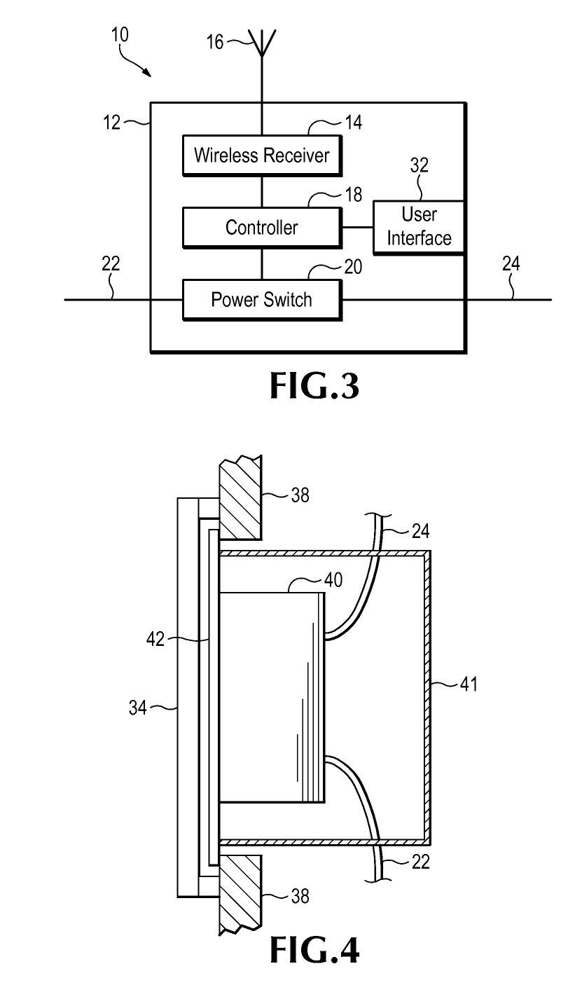

FIG. 3 illustrates another embodiment of a wireless occupancy sensing system having an accessible electrical box according to some of the inventive principles of this patent disclosure. In this embodiment, the system 10 includes a user interface 32. The user interface 32 can be included to enable a user to configure the system, adjust parameters, etc. For example, the user interface may enable a user to set an unoccupied delay time, detector sensitivity, learn mode, etc. A user interface may be implemented with any level of sophistication from a simple push-button switch with no user feedback to a keypad with full text display, or any combination of such interfaces. For example, the user interface 32 can include a trim pot, a potentiometer with a knob, an optical encoder, a keypad and display, a serial interface such as a universal serial bus (USB) interface, RS232 interface, inter-integrated circuit (I²C) interface, a wireless interface, or any other type of user interface.

In an embodiment, the user interface 32 may be accessible to the user at the accessible electrical box 12. In this example, as the accessible electrical box 12 is a wall box, the user interface 32 is located at the wall box. Accordingly, a user can easily change the parameters used in controlling power to a load in response to a wireless occupancy sensor, which can be located in a remote location, such as on a ceiling. For example, through the user interface 32, a user can set the various parameters associated with a wireless occupancy sensor described above. Using unoccupied delay time as an example, a user can select an unoccupied delay time.

Although the configuration of the usage of signals from a wireless occupancy sensor has been described, the control of other sensors can also be configured through the user interface 32. For example, the usage of signals from a wireless switch can be configured through the user interface 32.

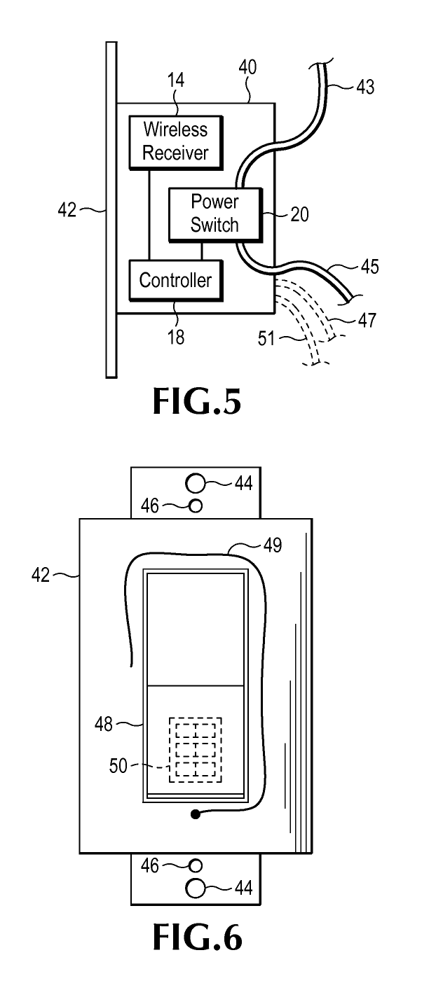

FIG. 4 illustrates an embodiment of a system mounted in a wall box according to some of the inventive principles of this patent disclosure. In this embodiment, the system includes a housing 40. The housing 40 can be mounted in an accessible electrical box, such as a wall box 41. The housing 40 can include the wireless receiver 14, the controller 18, and the power switch 20 described above. FIG. 5 illustrates an example of the system of FIG. 4 according to some of the inventive principles of this patent disclosure.

The housing 40 includes a flange 42 that is configured to be used to mount the housing 40 to an accessible electrical box. In this example, the accessible electrical box is a wall box 41 installed in a wall 38.

The wall box 41 is concealed by a trim plate 34. As described above, the system can include switches, a user interface, or the like. The trim plate 34 can expose such switches, a user interface, or the like. For example, an opening in the trim plate 34 can expose a SPST switch.

Although the trim plate 34 can expose a user interface, the user interface can be concealed by other structures. For example, the switch can be moved to expose multiple switches for setting various parameters for responsivity to an occupancy sensor. Thus, switching of power to loads can be configured at a location that is remote from the occupancy sensor. In particular the switching can be configured in a location that is more accessible than common locations for occupancy sensors.

In an embodiment, the electrical connections through the housing 40 can be made through pigtail wire leads 43, 45, 47, and 51. In this embodiment, wire leads 43 and 45 can be configured to be connected to building wiring for a power source and a load, respectively. Wire leads 47 can be connected to a ground for the housing 40, the flange 42, a combination of such structures, or the like. Wire leads 51 can be a neutral wire for connection to neutral wiring in the wall box 41. Although pigtail wire leads have been described for connections through the housing, various other types of connections can be used. For example, screw terminals, quick connect terminals, or the like can be used to couple the system to power sources, loads, or the like.

In this embodiment, wire leads 47 and 51 are illustrated in phantom. That is, a ground wire lead and a neutral wire lead may not be present. In particular, in some embodiments, such wires are not necessary and/or not used. For example, power for electronics in the wall box 41 can be obtained through wire leads 43 and 45 when the wire leads 43 and 45 are coupled to a load wire and a hot wire of building wiring.

In another embodiment, the housing 40 can be a double-insulated housing. For example, the housing 40, flange 42, and the like can be formed of insulating materials such as plastic, resin, or the like. As a result, wire leads 47 for a ground connection can, but need not be included. The housing 40 can be installed within a wall box 41 or other accessible electrical box that is not grounded and/or does not include a ground connection.

FIG. 6 illustrates another example of the module of FIG. 4 according to some of the inventive principles of this patent disclosure. In this embodiment, a switch 48 is disposed on an exterior of the housing 40. Accordingly, the switch 48 can be accessible when the housing 40 is installed in an accessible electrical box such as the wall box 41 as described above.

In an embodiment, the user interface 50 can be concealed behind a portion of the switch. In this embodiment, the user interface 50 includes a series of dual in-line package (DIP) switches. In another embodiment, the user interface 50 can be disposed adjacent to the switch 48. In such a configuration, the user interface 50 can be concealed by a trim plate 34. As described above, the user interface 50 can enable a user to adjust a parameter for controlling the power switch 20 in response to the wireless signal. In an embodiment, accessing the user interface 50 can disable power in the housing 40. For example, moving the portion of the switch can cause the electrical contact to be broken. The electrical contact can be broken at a hot wire, a load wire, through the controller 18, or the like.

In an embodiment, an antenna 49 can be coupled to the wireless receiver 14. The antenna 49 can be disposed around the switch 48. The antenna 49 can be disposed on exterior of the housing 40.

In an embodiment, the flange 42 can include mounts for mounting the housing 40 to an accessible electrical box. For example, an accessible electrical box can have holes configured to receive fasteners. Mounts 44 can be configured to accept a fastener to attach the flange 42 to the accessible electrical box. In addition the flange 42 can include mounts 46 for mounting a trim plate to the housing 40.

As used herein a mount is a structure used in attaching at least two structures together. For example, a mount can be used to attach the flange to the accessible electrical box. In this embodiment, the mounts 44 and 46 can be a hole through which a fastener can pass. A fastener can be a screw, a nail, a rivet, or the like. Any fastener that can attach two structures together can be used as appropriate to the flange 42.

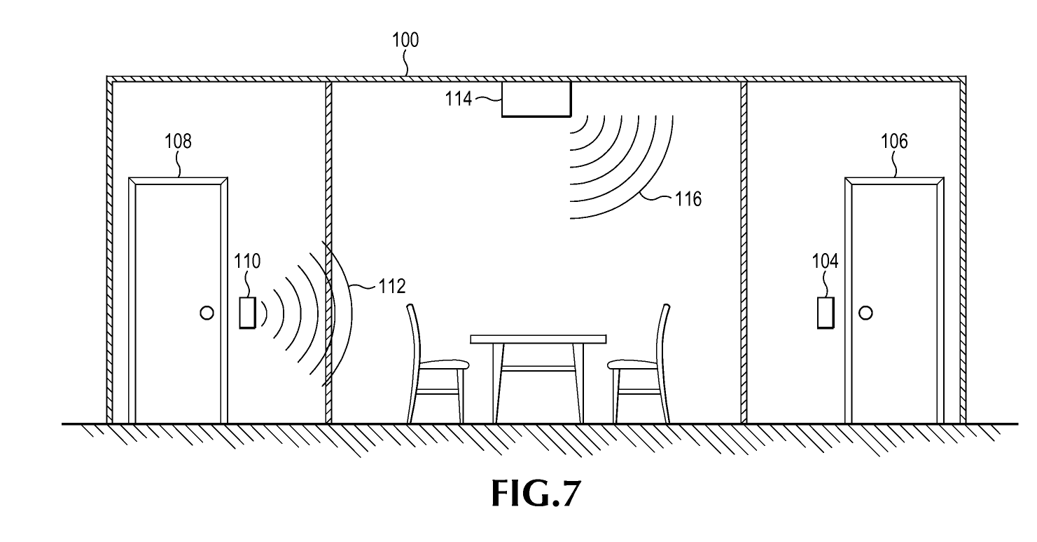

FIG. 7 illustrates another embodiment of a wireless occupancy sensing system having an accessible electrical box according to some of the inventive principles of this patent disclosure. In this embodiment, the system is installed in a room 100. For example, the room 100 can be a meeting room. A wireless occupancy sensor 114 can be installed on a ceiling of the room. The wireless occupancy sensor 114 can be configured to sense signals related to occupancy.

In some embodiments, the wireless signal from the wireless occupancy sensor 114 can include an occupancy signal that provides a relatively high-level indication of whether the monitored space is occupied or not. For example, the occupancy signal may be encoded as a binary signal where one state indicates the space is occupied, and the other state indicates the space is not occupied. A binary occupancy signal may have refinements such as a delay time integrated into the signal, i.e., the signal does not switch from the occupied to the unoccupied state until the space has been unoccupied for the entire duration of the delay time.

In other embodiments, the wireless signal from the occupancy sensor 114 can include a detector signal that provides a relatively low-level indication of a physical stimulus being sensed by a detector in the occupancy sensor. For example, in an occupancy sensor that uses passive infrared (PIR) sensing technology, the detector signal may be encoded to transmit primitive signals or raw data from the PIR detector. Such signals or data may then be processed in the accessible electrical box 104 to determine whether the monitored space is occupied. As described above, the system can use any such high-level signals, low-level signals, intermediate-level signals, or combination of such signals.

The accessible electrical box 104 can include a wireless receiver, a power switch to control power to a load; and a controller as described above. In an embodiment, the room 100 can include multiple accessible electrical boxes 104. The multiple accessible electrical boxes 104 can each be responsive to the same occupancy sensor 114. For example, one accessible electrical box 104 may be the wall box illustrated in FIG. 7. Another accessible electrical box 104 can be a floor box (not shown). As described above with respect to multiple power switches, multiple loads can be controlled with similar or different functions with multiple accessible electrical boxes 104. For example, the wall box 104 can be configured to turn off overhead lighting as soon as an occupant has left the room. However, the floor box can be configured to turn off another load, such as a projector, a computer, printer, monitor, or the like after a longer time delay

In an embodiment, the wireless occupancy sensor 104 can be configured to transmit a signal indicating that an occupant was detected. As described above, such a signal indicating that an occupant was detected can be transmitted periodically. In addition, as described above, the wireless occupancy sensor 104 may be configured to not transmit a signal indicating that an occupant was not detected.

In an embodiment, a wireless switch 110 can be installed in the room 100. The wireless switch 110 can be separate from the accessible electrical box 104. The controller of the accessible electrical box 104 can be configured to control the power switch in the accessible electrical box 104 in response to the wireless switch 110. For example, the wireless switch 110 can transmit a switch signal 112. The module installed in the accessible electrical box 104 can be configured to receive the switch signal 112. The power to a load can be controlled in response to the switch signal 112.

An example of the operation of the system installed in the room 100 will be described. A first signal indicating occupancy can be detected in the wireless occupancy sensor 114. For example, a variety of signals can be sensed to make a determination regarding occupancy. For example, infrared energy can be sensed, a video image can be captured, an audio signal can be captured, or the like. Any such signal can be the first signal indicating occupancy.

Once detected, a second signal can be transmitted indicating the occupancy. For example, wireless occupancy sensor 114 can be configured to transmit a detector signal that provides a relatively low-level indication of a physical stimulus being sensed by the detector 52 in the occupancy sensor. For example, in an occupancy sensor that uses PIR sensing technology, the wireless occupancy sensor 114 may transmit the value of the voltage output from the PIR detector in analog or digital form on the wireless signal 116. The controller in the accessible electrical box 104 can then perform the processing to determine whether a change in the amount of infrared energy received at the wireless occupancy sensor 114 is caused by the motion of an actual occupant. The controller can include logic to implement features such as a delay time, sensitivity adjustment, or the like in response to the wireless signal 116 and make an occupancy determination to control the flow of power.

In some embodiments, the signal processing functions may be distributed between multiple components. For example, the wireless occupancy sensor 114 can include some rudimentary signal processing in which the detector signal is converted to a digital form with an analog-to-digital converter (ADC), comparator, or the like. In such an embodiment, some amount of filtering may be included in the occupancy sensor as well. The digitized detector signal may then be transmitted in the wireless signal 116. Additional signal processing at the accessible electrical box 104 can complete the processing to make the occupancy determination.

In other embodiments, signal processing for multiple detectors may be distributed between multiple components. For example, with an occupancy sensor that uses a combination of PIR and video sensing, the signal processing for the PIR detector, which may require relatively little processing power, may be performed at the occupancy sensor, while processing for the video detector, which may require more processing power, may be performed at the portable switching device. In this example, the wireless signal may include a binary occupancy signal relating to the PIR portion, and a more complex detector signal relating to the video portion. Logic at the accessible electrical box may combine the binary PIR occupancy signal with the output from the video processing to make a final occupancy determination.

Moreover, controls, parameters, configurations or the like relating to the occupancy determination can be accessible to a user at the accessible electrical box 104. For example, a delay time related to the PIR portion and image processing parameters for the video portion can be located at the accessible electrical box 104. Any such parameter, control, configuration, or the like relating to the various sensors can be adjusted at the accessible electrical box 104 through a user interface at the accessible electrical box 104. Accordingly, the power to a load can be controlled according to the received signals and the various settings.

The user interface may be included to enable a user to configure the system, adjust parameters, etc. For example, the user interface may enable a user to set an unoccupied delay time, detector sensitivity, learn mode, etc. The user interface at the accessible electrical box 104 can be implemented with any level of sophistication from a simple push-button switch, to a keypad with full text display, etc. For example, in some embodiments, a user interface may include a trimming potentiometer (trim pot) to set a delay time for unoccupied mode.

In an embodiment, the wireless signal 116 relating to occupancy can include only signals related to occupancy if an occupant was detected. That is, a wireless signal 116 is only transmitted if an occupant is detected. In an embodiment, the wireless occupancy sensor 114 can be configured to only transmit the wireless signal 116 at less than a maximum rate. For example, the wireless occupancy sensor 114 can be configured to transmit a signal less than once per minute.

Although not illustrated, any variety of power sources can be used to power the accessible electrical box 104, the wireless occupancy sensor 114, and the wireless switch 110. For example, the power source can be provided from an external source, such as a hardwired connection to a 24 VDC power supply, a 120 VAC branch circuit, etc. In other embodiments, the power source may be internal, for example, one or more batteries, fuel cells, photovoltaic (PV) cells, etc. Other embodiments may include combinations of these various types of power sources. For example, primary power may be provided by a 120 VAC circuit, which maintains a backup battery in a charged state to provide power in the event of a loss of the 120 VAC circuit.

Such power sources can be used to operate the wireless receiver, controller, user interface, logic, etc. Alternatively, a separate power source such as one or more batteries, PV cells, etc. may be used as a primary or back-up source of power to operate this circuitry.

In an embodiment, the wireless occupancy sensor 114 can be configured to have a power source that can obtain power from its environment. For example, as described above, PV cells can provide power to the wireless occupancy sensor 114. As described above, the wireless occupancy sensor 114 can be configured to transmit signals representing lower-level processed signals such as an occupied signal, a sensor state, a sensor value, or the like.

Accordingly, the wireless occupancy sensor 114 can, but need not include additional circuitry to provide higher-level processing. For example, the wireless occupancy sensor 114 need not include circuitry to determine an on/off state for a load. In contrast, any such processing can be performed in a controller at the accessible electrical box 104.

In addition, in an embodiment, the wireless occupancy sensor 114 can be configured to dynamically limit power. For example, a transmitter of the wireless occupancy sensor 114 can be configured to only be enabled, supplied with power, or the like when occupancy is detected. When occupancy is detected, an occupied signal can be transmitted. If occupancy is not detected, a non-occupied signal need not be transmitted. Thus, the transmitter need not be enabled and the corresponding energy need not be consumed. As a result, lower-power power sources, intermittent power sources, or the like, such as PV cells, can be used to operate the wireless occupancy sensor 114. Although the enabling of the transmitter has been described in relation to the transmission of an occupied signal, the transmitter can be enabled for other purposed. For example, the wireless occupancy sensor 114 can be configured to enter a learn mode, transmit a learn signal, or the like. Accordingly, the transmitter can be enabled for such operations.

Moreover, although the selective enabling of a transmitter has been described, other circuitry can also be selectively enabled. For example, circuitry for generating a learn signal can be disabled until the pressing of a switch causes power to be supplied to the circuitry. Any combination of such selective enabling of circuitry can be used.

The inventive principles of this patent disclosure have been described above with reference to some specific example embodiments, but these embodiments can be modified in arrangement and detail without departing from the inventive concepts. For example, some of the embodiments have been described in the context of lighting loads, but the inventive principles apply to other types of electrical loads as well. Any of the circuitry and logic described herein may be implemented in analog and/or digital hardware, software, firmware, etc., or any combination thereof. As another example, some of the embodiments have been described in the context of interior building spaces, but the inventive principles apply to exterior or hybrid spaces as well. Such changes and modifications are considered to fall within the scope of the following claims.

1. A system comprising:
an accessible electrical box;
a wireless receiver to receive a wireless signal from an occupancy sensor;
a power switch to control power to a load; and
a controller to control the power switch in response to the wireless signal;
where the wireless receiver, controller, and power switch are included in the accessible electrical box.

2. The system of claim 1 where the controller is configured to control the power switch to apply power to the load in response to an occupied signal in the wireless signal.

3. The system of claim 2 where the controller is configured to control the power switch to remove power from the load if another occupied signal in the wireless signal is not received during a time period.

4. The system of claim 1, where the controller is configured to control the power switch to apply power to the load in response to an occupied signal if the occupied signal is received within a time period after the controller controlled the power switch to remove power from the load.

5. The system of claim 1 further comprising a switch included in the accessible electrical box where the controller is configured to control the power switch in response to the switch.

6. The system of claim 1 further comprising a trim plate to expose the switch and cover an interface between the accessible electrical box and a wall.

7. The system of claim 1 where the accessible electrical box is a wall box.

8. The system of claim 1 further comprising a user interface included in the accessible electrical box to enable a user to adjust a parameter for controlling the power switch in response to the wireless signal.

9. The system of claim 8 where the parameter comprises a time period.

10. A method comprising:
receiving a wireless signal from an occupancy sensor outside of an accessible electrical box; and
controlling power to a load in response to the wireless signal;
where the wireless signal is received at the accessible electrical box; and
where the power is controlled by a power switch in the accessible electrical box.

11. The method of claim 10 further comprising:
receiving an occupied signal in the wireless signal; and
turning on the power to the load in response to the occupied signal.

12. The method of claim 11 further comprising turning off the power to the load if another occupied signal in the wireless signal is not received within a time period.

13. The method of claim 11 further comprising:
turning off power to the load; and
turning on the power to the load if the occupied signal is received within a time period after turning off power to the load

14. The method of claim 10 further comprising:
receiving a switch signal from a switch located at the accessible electrical box; and
controlling the power to the load in response to the switch signal.

15. A system comprising:
a wireless occupancy sensor to generate a wireless signal; and
an accessible electrical box, the accessible electrical box including:
a wireless receiver to receive the wireless signal;
a power switch to control power to a load; and
a controller to control the power switch in response to the wireless signal;
where the wireless occupancy sensor is separate from the accessible electrical box.

16. The system of claim 15 where the wireless occupancy sensor is configured to transmit a signal indicating that an occupant was detected.

17. The system of claim 16 where:
the wireless occupancy sensor is configured to not transmit a signal indicating that an occupant was not detected; and
the controller is configured to control the power switch to remove power from the load if the signal indicating that an occupant was detected is not received within a time period.

18. The system of claim 15 further comprising a wireless switch separate from the accessible electrical box where the controller is configured to control the power switch in response to the wireless switch.

19. A method comprising:
detecting a first signal indicating occupancy;
transmitting a second signal indicating the occupancy in response to the detected first signal;
receiving the second signal at an accessible electrical box; and
controlling power to a load in response to the second signal.

20. The method of claim 19 where transmitting the second signal comprises only transmitting signals related to occupancy if an occupant was detected.

21. The method of claim 20 further comprising turning off power to the load if a signal related to occupancy is not received within a time period.

22. The method of claim 19 further comprising:
transmitting a switch signal from a wireless switch;
receiving the switch signal at the accessible electrical box; and
controlling the power to the load in response to the switch signal.

23. A system comprising:
an assembly including a mount to attach the housing to an accessible electrical box;
a wireless receiver to receive a wireless signal from an occupancy sensor;
a power switch to control power to a load; and
a controller to control the power switch in response to the wireless signal;
where the wireless receiver, power switch, and controller are included in the assembly.

24. The system of claim 23 where the assembly is included in a housing, the system further comprising a switch disposed on an exterior of the housing.

25. The system of claim 24 further comprising an antenna coupled to the wireless receiver, the antenna disposed around the switch.

26. The system of claim 23 the flange further comprising a second mount to attach a trim plate to the assembly.

27. The system of claim 23 further comprising an input disposed on the assembly to enable a user to adjust a parameter for controlling the power switch in response to the wireless signal.
